(19) United States
(12) Patent Application Publication
(10) Pub. No.: US 2008/0180641 A1
(43) Pub. Date: Jul. 31, 2008

(54) TRIPLE MONO-COLOR LIGHT SOURCE PROJECTOR

(76) Inventor: Kuo Ching CHIANG, Linkou Township (TW)

Correspondence Address: THE MAXHAM FIRM, 9330 SCRANTON ROAD, SUITE 350, SAN DIEGO, CA, 92121, US

(21) Appl. No.: 11/734,175

(22) Filed: Apr. 11, 2007

Related U.S. Application Data
(63) Continuation-in-part of application No. 11/701,158, filed on Jan. 31, 2007.

(51) Int. Cl. G03B 21/14

(52) U.S. Cl. 353/33; 977/952

(57) ABSTRACT

A projection display module coupled to a control IC for data projection. The projection display module includes three liquid crystal panels that perform image displays in red, green, and blue, respectively, and light emitting sources that are employed and positioned in correspondence with the liquid crystal panels, respectively. A prism is used for each display color combination, wherein the liquid crystal panels and the light emitting sources are positioned on the light-incidence side of the side surfaces of the prism. A projection lens is provided on the light-emission side of the prism.

### CROSS REFERENCE TO RELATED APPLICATION

The application is a continuation-in part application of Ser. No. 11/701,158, filed on 31 Jan. 2007, entitled “Panel Form Light Emitting Source Projector.”

### FIELD OF THE INVENTION

The present invention relates generally to a portable terminal and more particularly to a three mono-color light source projector.

### BACKGROUND OF THE INVENTION

Cellular communications systems typically include multiple base stations for communicating with mobile stations in various geographical transmission areas. Each base station provides an interface between the mobile station and a telecommunications network. Mobile telephone systems are in use or being developed in which the geographic coverage area of the system is divided into smaller separate cells, it communicates with the network via a fixed station located in the cell. Mobile telephones belonging to the system are free to travel from one cell to another. When a subscriber within the same system or within an external system wishes to call a mobile subscriber within this system, the network must have information on the actual location of the mobile telephone.

Recently, the price of cellular telephone has been greatly reduced and become affordable to lots of people. It is common that a person owns more than one cellular phone. Some people even replace their cellular telephones as often as they replace their clothes or hairstyle. The cellular manufactures have to release new models with different appearances, function and styles more frequently so as to attract the attention of the buyer and occupy a favorable marketing share. Furthermore, the conventional projector employ white light lamp as a light source, therefore, at least two reflector lens and at least three light-split lens are required to split the white light into three colors (red, green and blue). The optical lens set is expensive. The mechanism of the optical system is too complicated and the size can not be reduced. Further, the lamp source will generate heat with high temperature.

### SUMMARY OF THE INVENTION

The object of the present invention is to provide a projector with panel form light source.

The portable device comprises a control IC imbedded in the projector and a projection display module for the data projection. The projection display module includes three liquid crystal panels that perform image displays in red, green, and blue, respectively; light emitting sources employed and positioned in correspondence with the liquid crystal panels, respectively. A dichroic prism is used for each display color combination, wherein the liquid crystal panels and the said light emitting sources are positioned on the light-incidence side of the dichroic prism. A projection lens is provided on the light emission side of said dichroic prism to enlarge the projection image. Wherein said light emitting sources are organic EL (electroluminescence) elements that capable of emission of red, green, and blue light.

A portable device comprises a central control IC imbedded in said portable device; a RF module coupled to the control IC for wireless communication and a display, memory and an input unit coupled to the control IC. A pinhole camera detector embedded in said portable device, said pinhole camera detector is sensitive to a transmittance frequency from about 300 MHz to 2.5 GHz.

A further aspect of the present invention is to disclose a portable device comprising a control IC imbedded in the portable device; a RF module coupled to the control IC for wireless communication; a display, memory and an input unit coupled to the control IC; and a remote control module coupled to said central control IC to control lock or a device by the key code coded in the memory.

Another embodiment of the present invention comprises a control IC imbedded in a portable device; a RF module coupled to the control IC for wireless communication; a display, memory and an input unit coupled to the control IC; and an alcohol ingredients detecting module is provided and coupled to the control IC to detect alcohol containment.

In order to achieve the object of the present invention, a portable device comprises a control IC imbedded in the portable device; a RF module coupled to the control IC for wireless communication; a display, memory and an input unit coupled to the control IC; and an illumination source embedded in the portable device for acting as pointer or flashlight. The illumination source includes a laser component. Wherein the illumination source include a lamp (or LED) and a reflector position in accordance with the lamp to reflect light generated by the lamp.

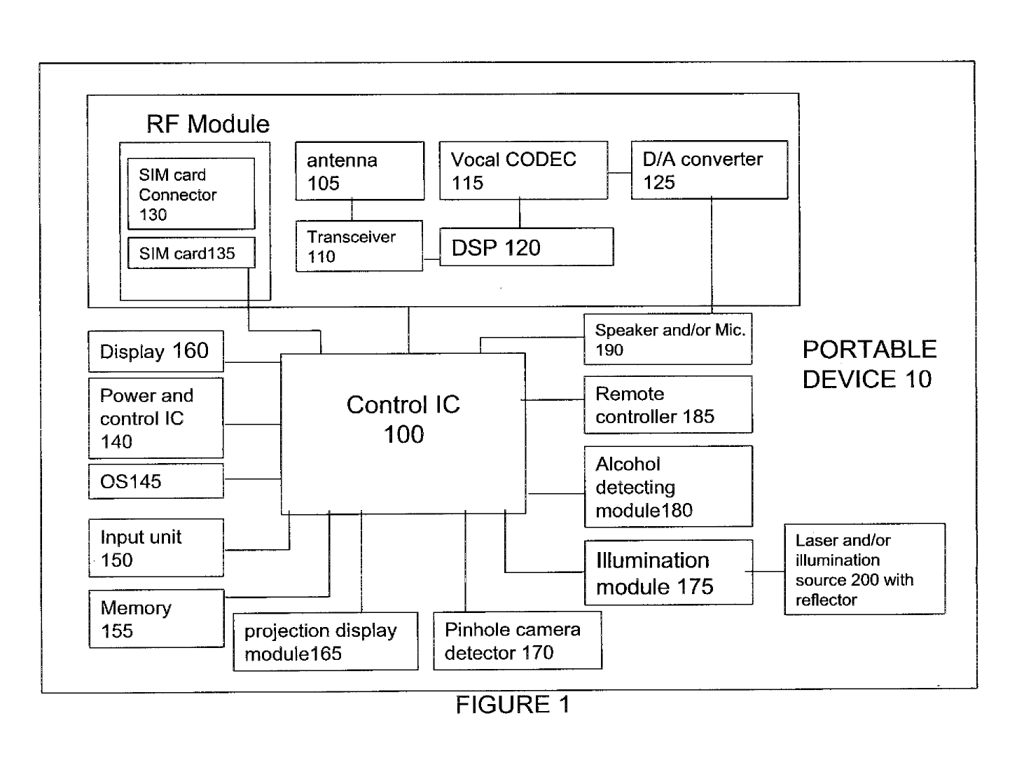

FIG. 1 shows a diagram of a cellular terminal according to the present invention.

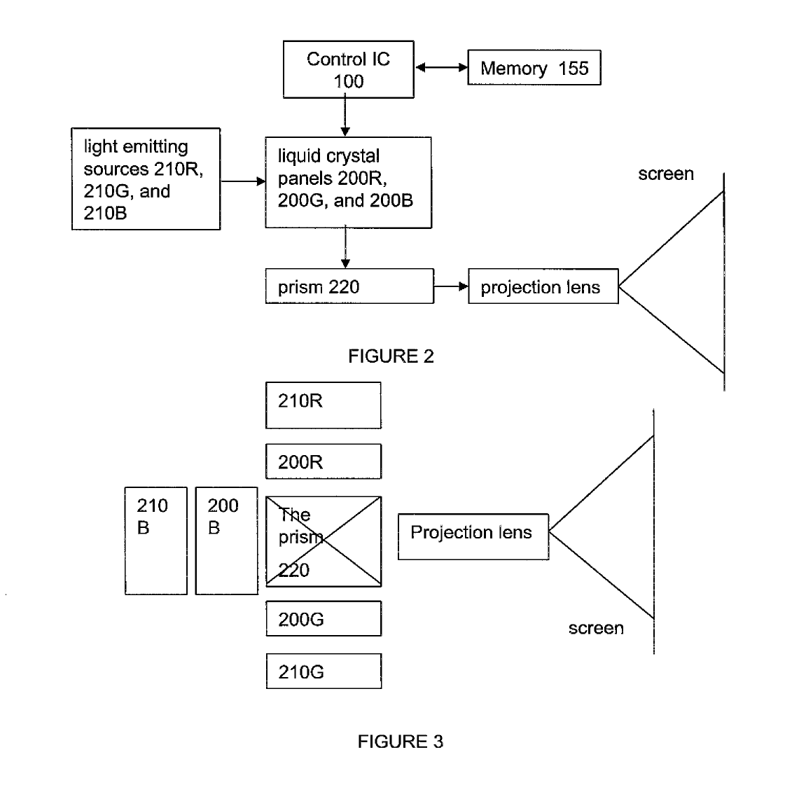

FIG. 2 shows a diagram of a projection display module according to the present invention.

FIG. 3 shows a diagram of a projection display module with EL as the illumination source according to the present invention.

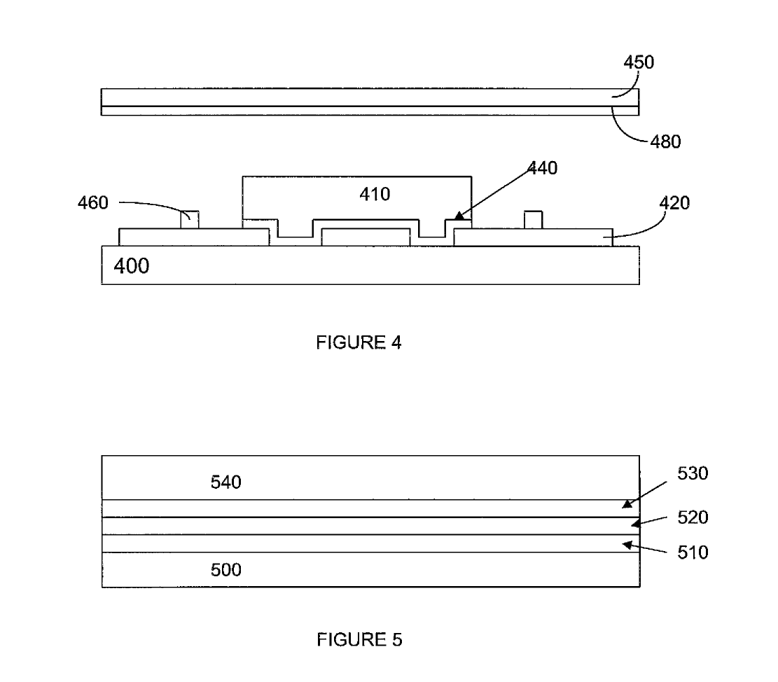

FIG. 4 shows a diagram of light emitting source according to the present invention.

FIG. 5 shows a diagram of light emitting source according to the present invention.

### DETAILED DESCRIPTION

The present invention relates generally to a multi-function portable terminal. The portable terminal includes but not limited to cellular phone, PDA (personal digital assistant), smart phone and the equivalent thereof.

FIG. 1 shows a block diagram of a portable terminal with SIM card connector 130 to carry the SIM card 135, it is well know in the art, the SIM card is not necessary for some other type of cellular such as PHS system. The diagram is used for illustrating and not used for limiting the scope of the present invention. The portable terminal or device 10 includes a RF module. As know in the art, the RF module includes antenna 105. This antenna 105 is connected to a transceiver 110, which is used to receive and transmit signal. AS know, the RF module further includes CODEC 115, DSP 120 and A/D converter as well. Due to the RF module is not the feature of the present invention, therefore, the detailed description is omitted. The present invention includes a central control IC 100, an input unit 150, a build-in display 160, OS 145, power and control IC 140 and memory 155 including a ROM program memory, a RAM memory and a nonvolatile FLASH memory. The RF module may perform the function of signal transmitting and receiving, frequency synthesizing, base-band processing and digital signal processing. The SIM card hardware interface is used for receiving a SIM card. Finally, the signal is send to the final actuators, i.e. a loudspeaker and a microphone 190.

The present invention includes one or more following module that is not disclosed by the current cellular terminal. It should be noted that the additional module can be implanted along or combination depending on the necessary.

A pinhole camera detector 170 indicates the addition of a device, which is apt to wireless or wired signal. The pinhole camera detector is sensitive to the transmittance frequency, for example, from the 300 MHz to 2.5 GHz, and is coupled to the control IC 100. The detector also includes a switch coupled to pinhole camera detector to active the detector. As known, the pinhole video camera includes a printed circuit board, a charged coupled device (hereinafter referred to as “CCD”), memory means for storing a single frame image which is generated by image signal from the CCD and a signal converting means, a connector with wires to connect the aforementioned circuits to power source and the displayer. A conical convex lens is accommodated to have an apical angle and the apex is fixed so as to face the pinhole. The pinhole camera detector 120 is available to scan and detect the operation frequency while the pinhole camera is in function. The so-called spy camera could also be detected by the pinhole camera detector 120 as well. The scanned result can be send to the display 160 and/or the loudspeaker and a microphone 190, thereby sending an alarm signal.

Moreover, the portable terminal according to the present invention shown in FIG. 1 has another function module. An embodiment is now described with reference to FIG. 2. A projection display module 165 is coupled to the control IC 100. One type of such a projection display module 165 that is known is the liquid crystal projector wherewith images on a liquid crystal panel are enlarged and projected by a projection lens onto a reflective screen and thus displayed. The liquid crystal projection display module comprises a light source lamp unit inside a shell of the device. Electrical discharge lamps such as metal halide lamps, or halogen lamps, could be used in the light source lamp unit. The light emitted from this light source lamp unit is guided via a mirror to dichroic mirrors, whereby it is separated into red light, green light, and blue light. The images displayed on the three liquid crystal panels, respectively, are illuminated by their respective colors, and this light is combined by a dichroic prism.

In preferable embodiment, please refer to FIG. 3, the liquid crystal projector comprises three liquid crystal panels 200R, 200G, and 200B that perform image displays in red, green, and blue, respectively. Preferably, panel-form light emitting sources 210R, 210G, and 210B is employed and positioned in correspondence with the liquid crystal panels, respectively. In one embodiment, the light emitting sources 210R, 210G, and 210B are organic EL (electroluminescence) elements. These organic EL elements are electric-field light emitting thin films that capable of emission of red, green, and blue light. The EL elements are formed behind and adjacent to the liquid crystal panels 200R, 200G, and 200B, respectively. The liquid crystal panels 200R, 200G, and 200B and the light sources 210R, 210G, and 210B are positioned on the light-incidence side of the side surfaces of the dichroic prism 220 for each display color combination. The projection lens 230 could be made up of a plurality of tenses. Thus, the data or file stored in the memory of the device can be projected on a screen or wall. It allows the user to project the image, game or file on an external screen. The EL element is small, flat form, light weight, therefore, it allows the small projection to be integrated in the portable device.

Alternatively, another embodiment of display is shown in FIG. 4, a cross-sectional view of the field emission display according to the present invention. As seen in FIG. 4, a transparent substrate 400 is provided and transparent electrodes 420 are formed on the glass substrate 400. The transparent electrodes 420 may be made of indium tin oxide (ITO) and may be used as the emitter electrodes. Stacked gates 410 that cover a portion of the transparent electrodes 420 are formed on the glass substrate 400. Emitters 460 that emit electrons are formed on a portion of the transparent electrodes 420. Each stacked gate 410 includes a mask layer 440 that covers a portion of the transparent electrodes, and is formed by UV photolithograph mask. The mask layer 440 is preferably transparent to visible light, but opaque to ultra violet rays and can be made of an amorphous silicon layer. The silicon layer will be transparent when the thickness is thin enough. A stacked gate 410 structure includes a first insulating layer/a gate electrode/a second insulating layer/focus gate electrode, sequentially formed over the substrate. The gate insulating layer is preferably a silicon oxide thin film with a thickness of 2 mu.m or more and the gate electrode is made of chrome with a thickness of about 0.25 .mu.m. The gate electrode is used for extracting an electron beam from the emitter. The focus gate electrode performs as a collector for collecting electrons emitted from emitter so that the electrons can reach a fluorescent film 480 disposed above the emitter 460. If the device is used for display, the substrate can be silicon or transparent substrate. Referring to FIG. 4, a front panel 450 is disposed upward and above the stacked gate. A variety of visual images are displayed on the front panel 450. A fluorescent film 480 is attached to a bottom surface of the front panel 450 that faces the stacked gate and a direct current voltage is applied to the fluorescent film 480 to emit color for display. The fluorescent substance may emit color light by mixing the emitted light if the thin film with R, Q B fluorescent substances. Preferably, the present invention includes three such emission displays that separately display image in red components, green components, and blue components (namely, red, green and blue images). The fluorescent substances that emit red, green, and blue visible light when excited by the electron beam are evenly distributed on the fluorescent film 480. Spacer separating the front panel 450 from the stacked gate is a black matrix layer and is not shown for convenience. Due to the thin film display if formed with thinner thick and the power consumption is lower than LCD, the present invention may provide a smaller size, lighter weight device. The life of the battery may be longer. The field emission device does not require complicated, power-consuming back lights and filters which are necessary for LCD. Moreover, the device does not require large arrays of thin film transistors, and thus, a major source of high cost and yield problems for active matrix LCDs is eliminated. The resolution of the display can be improved by using a focus grid to collimate electrons drawn from the microtips. Preferably, the emitter includes a carbon nanotube emitter to further reduce the device size. Further, the display may omit the liquid crystal material. Further, the field emission display does not require the S/D regions which are required by TFT for LCD. Preferably, LED source may irradiate mono color light. Namely, blue light, red light and green light LEDs are employed to act as the light source. In one case, the LED may be formed in a matrix or linear configuration. Please be noted that the elements with fluorescent substances shown in FIG. 4 (carbon nanotube field emission device) and FIG. 5 (ELP) can be used as light sources as well.

In another embodiment, the display is shown in FIG. 5. The display includes a transparent electrode 510 on a transparent substrate 500. A fluorescent film or powder 520 is attached to an upper surface of the lower transparent electrode 510. Preferably, the fluorescent substance emits color light. The present invention includes three such devices that separately display image in red components, green components, and blue components. Each irradiates single color light. Different powder will emit different color. An upper transparent electrode 530 is formed on the fluorescent film or powder 520. A second transparent substrate 540 is formed on the transparent electrode 530. A bias is applied on the electrodes to inject hole and electron, thereby exciting the fluorescent substances by the combination of the electron and hole to emit red, green, or blue visible light depending on the compound of the fluorescent substances. The elements may refer to ELP. In the examples, the light emitting device (LED) can be employed as the light source and the mechanism and process is more simple than LCD, and the manufacture cost is lower than LCD. Preferably, LED sources that irradiate blue light red light, and green light LEDs are employed as the three mono-color light sources.

Another aspect of the present invention is that the device 10 also includes remote control module 185. The remote control module 185 maybe used to control lock or device by the key code coded in the remote control module 185. The remote controller is also a mature technology. Remote controllers for electrical and electronic appliances are well known, and are widely used. In one example, the remote control module 185 applies infrared rays for transmission, and each company provides its appliances and remote controllers with its specific protocol of communication. An example of the remote control module 185 is provided with an interface for downloading the relevant information into the remote control module 185 from an external source. In one embodiment of remote controller is provided with an infrared transmitter for sending remote controlling signals to the appliance. The remote controller is provided with a RAM or ROM, or EPROM, or EEPROM internal database (memory 155) to which set-up information regarding the key-map and signal format of at least one apparatus to be controlled is entered. Such information can be commonly provided to the internal database from various sources, such as from a smart card, from an Internet database, from a plugged-in card, etc. The database in the appliance contains set-up data that can be transmitted by transmitter to the remote control module 185 providing it all the information it needs in order to control the appliance. The present invention uses the RF module to download the key code from database through network.

Another aspect of the present invention is that the portable device 10 also includes an alcohol detecting module 180. The alcohol ingredients detecting module 180 is provided and coupled to the control IC 100 to detect the alcohol ingredients from one's breath, for example, the module is capable of detecting alcohol content. The alcohol detecting module 180 is sensitive to the aforementioned alcohol content. If the bonding is detected, the signal will be send from the alcohol detecting module 180 to the control IC 100 for determine the level of the alcohol ingredients. Then, the result will be send to the display 160. U.S. Pat. No. 5,907,407 had disclosed various methods to detecting the alcohol. U.S. Pat. No. 4,809,810 disclosed a system both apparatus and method, for analyzing a breath sample.

Further, an illumination module 175 is also employed by the present invention. The portable device could be used as a laser pointer if the illumination module 175 includes a laser component 200. A switch can be provided to active the laser. In another embodiment, the illumination module 175 includes a light source to allow the portable device to be used as the flashlight. Especially, one may turn on the illumination module 175 in dark environment such as in a theater. The illumination module 175 could be coupled to the control IC 100 or implanted with an independent control IC. The illumination source includes a laser component. Wherein the illumination source include a lamp (or LED) and a reflector position in accordance with the lamp to reflect light generated by the lamp.

As will be understood by persons skilled in the art, the foregoing preferred embodiment of the present invention is illustrative of the present invention rather than limiting the present invention. Having described the invention in connection with a preferred embodiment, modification will now suggest itself to those skilled in the art. Thus, the invention is not to be limited to this embodiment, but rather the invention is intended to cover various modifications and similar arrangements included within the spirit and scope of the appended claims, the scope of which should be accorded the broadest interpretation so as to encompass all such modifications and similar structures. While the preferred embodiment of the invention has been illustrated and described, it will be appreciated that various changes can be made therein without departing from the spirit and scope of the invention.

What is claimed is:

1. A projector comprising:
a prism used for each display color combination;
three image displays that display images in red, green, and blue, respectively, positioned on the light-incidence side of said prism, wherein each said image display includes a transparent substrate having a transparent electrode formed thereon, a stacked gate formed over said substrate and emitters formed adjacent to said stacked gate, a transparent panel having fluorescent substances spaced apart from said transparent substrate, wherein said fluorescent substances emit green, blue, or red light;
three light sources positioned in correspondence with said three image displays to respectively emit red, green, and blue light, wherein said three image displays and said three light sources are positioned on light-incidence side of said prism; and
a projection lens positioned on light emission side of said prism to enlarge the projection image.

2. The projector of claim 1, wherein each said light source includes organic electroluminescence elements that are capable of emission of red, green, or blue light.

3. The projector of claim 1, wherein each said light source includes LED elements that are capable of emission of red, green, or blue light.

4. The projector of claim 1, wherein each said light source includes carbon nanotube emitter elements that are capable of emission of red, green, or blue light.

5. The projector of claim 1, wherein said emitter includes carbon nanotube emitters.

6. A projector comprising:
a prism used for each display color combination, said prism having a light-incidence side and a light-emission side;
three image displays that perform image displays in red, green, and blue, respectively, are positioned on the light-incidence side of said prism;
three light sources positioned in correspondence with said three image display to emit red, green, and blue light, respectively, wherein said three image display panels and said three light sources are positioned on the light-incidence side of said prism, wherein said three light sources are selected from ELP, field emission device, LED, and OEL; and
a projection lens positioned on the light-emission side of said prism to enlarge the projection image.

7. The projector of claim 6, wherein said image displays are selected from carbon nanotube emitter display, ELP, and LCD.

8. A projector comprising:
a prism used for each display color combination, said prism having a light-incidence side and a light-emission side;
three image displays that display images in red, green, and blue, respectively, positioned on the light-incidence side of said prism, wherein each said image display includes a first transparent electrode formed thereon, a substrate having a second transparent electrode, fluorescent substances formed between said first and second substrate, wherein said fluorescent substances emit green, blue, or red light;
three light sources positioned in correspondence with said three image displays to respectively emit red, green, and blue light, wherein said three image displays and said three light sources are positioned on the light-incidence side of said prism; and
a projection lens positioned on the light-emission side of said prism to enlarge the projection image.

9. The projector of claim 8, wherein each said light source includes organic electroluminescence elements that are capable of emission of red, green, or blue light.

10. The projector of claim 8, wherein each said light source includes LED elements that are capable of emission of red, green, or blue light.

11. The projector of claim 8, wherein each said light source includes electroluminescence devices that are capable of emission of red, green, or blue light.

12. The projector of claim 8, wherein each said light source includes field emission devices that are capable of emission of red, green, or blue light.

13. The projector of claim 12, wherein said field emission device includes carbon nanotube emitters.
